(19) United States
(12) Patent Application Publication
(10) Pub. No.: US 2012/0202964 A1
(43) Pub. Date: Aug. 9, 2012

(54) COPOLYESTER AND PREPARATION METHOD AND USE THEREOF

(75) Inventors: Xu Li, Nantong (CN); Yawei Wu, Nantong (CN); Juan Yang, Nantong (CN); Masatoshi Aoyama, Mishima-shi (JP)

(73) Assignee: TORAY FIBERS & TEXTILE RESEARCH LABORATORIES (CHINA) CO., LTD., Nantong, Jiangsu (CN)

(21) Appl. No.: 13/499,080

(22) PCT Filed: Sep. 28, 2010
(86) PCT No.: PCT/CN10/77393

§ 371 Date: Mar. 29, 2012

(30) Foreign Application Priority Data
Sep. 29, 2009 (CN) 200910035632.0

(51) Int. Cl. C08G 63/672

(52) U.S. Cl. 528/301

(57) ABSTRACT

A copolyester and preparation method and use thereof are disclosed. In the diacid components constituting the copolyester, the content of the structure unit of terephthalic acid is 90 mol % or more. In the dihydric alcohol components constituting the copolyester, the content of the structure unit of ethylene glycol is 70-99 mol % and the content of the structure unit of aliphatic dihydric alcohol having 6 or less carbon atoms and having a side chain is 1-30 mol %. The copolyester further comprises a structure unit of polyethylene glycol. The copolyester can be made into fiber by common method, and further made into fabric, and the obtained finished-product has good dyeability to disperse dyes under normal temperature and normal pressure.

### FIELD OF THE INVENTION

This invention relates to a copolyester and preparation method and use thereof. Specifically, this invention relates to a copolyester obtained by co-polymerizing with a monomer of aliphatic diol having a side chain and a carbon atom number of 6 or less.

### BACKGROUND OF THE INVENTION

Polyethylene terephthalate in polyester has outstanding performance and has been widely used in the fields of fiber and film, etc., especially in the fields of clothing and industrial materials.

There is a variety of dyeing processes of polyester fiber depending on different usage. However, ordinary polyester is characterized by compact molecular chain and high crystallinity, which make the polyester harder to be dyed than natural fiber. When dyeing with disperse dye, a high temperature of 130° C. and high pressure are needed, which will lead to an increase in equipment investment and running cost.

The topic of how to increase the dyeing performance of polyester fiber has been studied for a long time. Among others, one of the main means to improve the properties of polymer is improvement of copolymerization technique.

Chinese Patent Publications CN101063236A and CN1534114A disclose processes of making polyester merely by copolymerizing with diol having a side chain. Though the dyeing performance of polyester fiber has been promoted, the lightness value L* of fiber is still relatively high after dyeing. If the amount of diol copolymerizing unit is increased, the dyeing performance of fiber can be promoted, but the crystallinity of polymer will deteriorate, leading to increase in shrinkage rate of the fiber during the dry heat treatment in the post processing of the fiber, and the feel of fabric thus obtained is hard, and therefore, the application of the fiber is enormously limited.

Japanese Patent Publication JP56-26006 discloses a process for improving the dyeability of a modified polyester fiber by adding sulfonic acid group and polyethylene alcohol monomer into polyester. However, the dyes used for fibers made from this type of polyester need to be cationic dyes rather than ordinary disperse dyes, and the production cost is thus increased.

### SUMMARY OF THE INVENTION

The object of this invention is to provide a copolyester having excellent dyeing performance at normal pressure and low cost, and preparation method and use thereof.

The technical solutions of this invention are as follows:

In the copolyester according to the invention, based on the diacid components constituting the copolyester, the content of terephthalic acid structural unit is 90 mol % or more; based on the diol components constituting the copolyester, the content of ethylene glycol structural unit is within the range of 70-99 mol %, and the content of aliphatic diol structural unit having a side chain and a carbon atom number of 6 or less is 1-30 mol %. The copolyester further contains polyethylene glycol structural unit.

In this invention, the aliphatic diol having a side chain and a carbon atom number of 6 or less includes 2-methyl-1,3-propanediol, 2,2-dimethyl-1,3-propanediol, 2-methyl-1,4-butanediol, 2,3-dimethyl-1,4-butanediol, 2-methyl-1,5-pentanediol, and 1,2-propanediol, and 2-methyl-1, 3-propanediol is preferred because the dyeing performance of a copolyester using 2-methyl-1,3-propanediol is excellent.

The amount of the aliphatic diol having a side chain and a carbon atom number of 6 or less used for the copolymerization must be such that the content of aliphatic diol structural unit having a side chain and a carbon atom number of 6 or less is 1-30 mol % based on the diol components constituting the copolymer. The dyeing performance of the copolyester proves good within this range. The preferred range is 6-20 mol %.

According to this invention, in order to improve the dyeing performance of a fiber using the copolyester, polyethylene glycol monomer is further added during the copolymerization reaction because the flexible chain structure of the polyethylene glycol monomer will make the fiber easy for dyes to disperse. Moreover, the addition of polyethylene glycol will decrease the dyeing temperature by reducing the compactness of the structure of polyester fiber.

The molecular weight of the polyethylene glycol monomer is 1,000-10,000 g/mol. The amount of the polyethylene glycol to be added is within the range of 1-30 wt % of the total amount of the copolyester. If it is out of this range, the heat resisting property of the copolymer will decrease and the spinnability of the copolymer becomes bad, leading to the possibility of flying yarn. According to the invention, by adding polyethylene glycol component, not only the dyeability of the fiber is improved, but also the severe reduction of the crystallinity of the polyester is avoided. Thereby, the dry heat shrinkage rate of the polyester fiber is not substantially increased and the feel of the fabric is not remarkably changed, so the application potentials of the polyester will not be limited.

According to the method for preparing the copolyester of this invention, the copolyester is prepared by polymerizing 100 parts by weight of diacid, 56-93.4 parts by weight of diol and 1.15-35 parts by weight of polyethylene glycol, wherein the content of terephthalic acid is 90 mol % or more based on the diacid, and the content of ethylene glycol and the content of aliphatic diol having a side chain and a carbon atom number of 6 or less are 70-99 mol % and 1-30 mol %, respectively, based on the diol. In this invention, the molar ratio of the diacid to the diol is 1:1.5-2.5.

The examples of the catalyst used for transesterification reaction or polycondensation reaction during the esterification in this invention include: calcium compounds such as calcium acetate and calcium chloride, magnesium compounds such as magnesium acetate, magnesium chloride and magnesium carbonate, antimony compounds such as antimony trioxide and antimony acetate, germanium compounds such as germanium oxide and germanium chloride, titanium alkoxides such as tetrabutyl orthotitanate and tetraisopropyl titanate, ethylene diamine tetraacetic acid, hydroxyethyliminodiacetic acid, diethylenetriamine pentacetic acid, triethylenetetramine hexaacetic acid, or titanium complexs containing polycarboxylic acid and/or hydroxycarboxylic acid and/or carboxylic acid containing nitrogen as a chelating agent. The chelating agent refers to any one or more selected from a group consisting of hydroxycarboxylic acids such as phthalic acid, tricarboxylic acid trioctyl ester, trimesic acid, hemimellitic acid, and pyromellitic dianhydride; or carboxylic acids containing nitrogen such as ehtylenediamine tetraacetic acid, NTP, carboxyimino diacetic acid, carboxymethylimino dipropionic acid, diethylenetriamine pentacetic acid, triethylenetetramine hexaacetic acid, iminodiacetic acid, iminodipropionic acid, N-(2-hydroxyethyl)iminoacetic acid, N-(2-hydroxyethyl)iminodipropionic acid and N-(2-methoxyethyl)iminoacetic acid.

The copolyester according to this invention can be prepared by either direct polymerization method or DMT method, and can be prepared by either batch process or continuous process.

In addition, the copolyester according to this invention can be made into fibers and can further be made into fabrics by conventional methods. The final product thus made has excellent dyeability to disperse dyes at normal pressure, thus reducing the expensive equipment investment and high running cost resulting from dyeing at high temperature and high pressure. Meanwhile the fiber product shows excellent physical properties and has broad application potentials.

### DETAILED DESCRIPTION OF THE INVENTION

The present invention will be further demonstrated with reference to the following examples, which are meant only to illustrate, but in no way to limit, the claimed invention.

The abbreviations used in the description have the following meanings: TPA: diacid containing terephthalic acid in a ratio of 90 mol % or more; EG: ethylene glycol; MPO: 2-methyl-1,3-propylene glycol; and PEG: polyethylene glycol.

### Example 1

Bis-hydroxyethyl terephthalate was added into an esterification reactor kept at a temperature of 250° C. and a pressure of 1.2×10⁵ Pa. A slurry of TPA (8.25 kg) and EG (3.54 kg) was gradually added into an esterification reaction layer over 4 hours and an esterification reaction was carried out for 1 hour. Finally, 10.2 kg was taken out of the esterification reaction product and added into a polycondensation reaction layer.

The esterification reaction product was kept at a temperature of 250° C. and under normal pressure, and PEG 1000 was added in a weight ratio of 1% relative to the finally obtained polyester. After stirring for 5 minutes, MPO was added in a molar ratio of 10% relative to the total amount of diol component in the finally obtained polyester, and the reaction mixture was further stirred for 30 minutes. To the reaction mixture, phosphoric acid was then added such that the content of phosphorus atom in the polymer was 18 ppm. Five minutes later, antimony trioxide and cobalt acetate were further added such that the content of antimony atom and the content of cobalt atom in the polymer were 230 ppm and 15 ppm, respectively. Another five minutes later, ethylene glycol slurry containing titanium oxide particles in a ratio of 0.3 wt % relative to the polymer was added. Five minutes later, the pressure was reduced to 40 Pa and the temperature was increased from 250° C. to 290° C. over 90 minutes. After reaching to a certain level of torque for stirring, nitrogen gas was introduced into the reaction system until the reaction system reached normal pressure, and the polycondensation reaction was then terminated. The polymer was extruded to form strands, and cooled in a water tank and cut into pellets. The intrinsic viscosity of the prepared polymer is 0.67.

The obtained pellets were dried until the pellets reached a level of moisture content of 50 ppm. Then the pellets were melt-spun at a spinning temperature of 290° C. and were wound up at a take-up speed of 3,000 m/min. The obtained undrawn yarn was drawn at a drawing temperature of 90° C. and a drawing ratio of 1.65, and then was wound up after heat treatment at a setting temperature of 130° C. A drawn yarn of 56 dtex/24 filaments was obtained.

The obtained yarn was circular-knitted and the dyeing performance thereof was evaluated according to the following conditions. The fabric was stirred with and dyed by a treatment solution in a high temperature dyeing test machine UR•MINI-COLOR (IR mini dyeing machine manufactured by TEXAM Co. Ltd.) at a temperature of 95° C. for 30 min. The reagents contained in the treatment solution were as follows:

| | | |
|---|---|---|
| 1) Dianix Blue E-Plus (manufactured by DyStar; disperse | 5% | owf |
| dye) | | |
| 2) NIKKA SUNSALT (NIKKA CHEMICALS; leveling | 1 | g/l |
| agent) | | |
| 3) Acetic acid (modifier of pH) | 0.5 | g/l |

After dyeing, the yarn was reduced and cleaned at a temperature of 80° C. for 20 min by using an aqueous solution comprising the following components.

| | | |
|---|---|---|
| 4) NaOH | 0.6 | g/l |
| 5) NaHSO₃ | 2 | g/l |

Then, the dyed circular-knitted fabric was washed with water and air-dried, and taken as a sample for dying evaluation. The sample was folded and overlapped in 8 layers and the color thereof was measured by using a spectrophotometer (Datacolor 650 manufactured by Datacolor Asia Pacific (H.K.) Ltd.). The result was L*=26.1, wherein L* is lightness in the L*a* b* color system, and the smaller the value is, the better the dyeing property of the fabric is.

Meanwhile the dry-heat shrinkage rate of the polyester fiber of this invention was also measured to confirm the broad application potentials of the polyester fiber. In this invention, the measuring method is as follows: a polyester fiber of 10 m is taken and wound in 10 circles. The fiber is heat-treated at 160° C. for 15 minutes and the length thereof is then measured. The dry-heat shrinkage rate of the fiber can be calculated by dividing the reduction in the length of the fiber by shrinkage by the original length of the fiber. The dry-heat shrinkage rate of normal PET polyester is around 8%-10%. If the shrinkage rate is too large, the feel of the fiber will become rough, and the application potentials of the fiber will thus be limited. In this invention, a fiber is considered as having excellent physical properties if its dry-heat shrinkage rate is below 15%, considered as having good physical properties if the dry-heat shrinkage rate is below 18%, good property, and considered as having bad physical properties if the dry-heat shrinkage is 18% or more.

It is apparent from the following comparative examples that the dyeing performance of the copolyester according to this invention under normal pressure has been greatly promoted in comparison with that of polyethylene terephthalate not copolymerized with MPO and PEG.

### Comparative Example 1

A polyester fabric was produced in the same manner as in Example 1 except for not adding PEG 1000. The obtained circular-knitted fabric was dyed at a dyeing temperature of 95° C. and the L* value thereof was measured to be 30.0. The dry-heat shrinkage rate of the fabric was found good.

### Comparative Example 2

A polyester fabric was produced in the same manner as in Example 1 except for not adding MPO and PEG 1000. The obtained circular-knitted fabric was dyed at a dyeing temperature of 95° C. and the L* value thereof was measured to be 37.5. The dry-heat shrinkage rate of the fabric was found excellent.

### Example 2

A polyester fabric was produced in the same manner as in Example 1 except for replacing PEG 1000 with PEG 4000. The obtained circular-knitted fabric was dyed at a dyeing temperature of 95° C. and the L* value thereof was measured to be 25.7. The dry-heat shrinkage rate of the fabric was found good.

### Example 3

A polyester fabric was produced in the same manner as in Example 1 except for replacing PEG 1000 with PEG 10000. The obtained circular-knitted fabric was dyed at a dyeing temperature of 95° C. and the L* value thereof was measured to be 28.1. The dry-heat shrinkage rate of the fabric was found good.

### Example 4

A polyester fabric was produced in same manner as in Example 1 except for replacing MPO with DMPO (2,2-dimethyl-1,3-propanediol). The obtained circular-knitted fabric was dyed at a dyeing temperature of 95° C. and the L* value thereof was measured to be 28.4. The dry-heat shrinkage rate of the fabric was found good.

### Example 5

A polyester fabric was produced in the same manner as in Example 1 except that for replacing MPO with EPED (2-methyl-1,5-pentanediol). The obtained circular-knitted fabric was dyed at a dyeing temperature of 95° C. and the L* value thereof was measured to be 29.2. The dry-heat shrinkage rate of the fabric was found good.

### Example 6

A polyester fabric was produced in the same method as in Example 1 except for replacing MPO with 1,2-PDO (1,2-propanediol). The obtained circular-knitted fabric was dyed at a dyeing temperature of 95° C. and the L* value thereof was measured to be 29.0. The dry-heat shrinkage rate of the fabric was vgood.

### Example 7

A polyester fabric was produced in the same manner as in Example 1 except that the amount of MPO was changed to 3 mol %. The obtained circular-knitted fabric was dyed at a dyeing temperature of 95° C. and the L* value thereof was measured to be 30.0. The dry-heat shrinkage rate of the fabric was found excellent.

### Example 8

A polyester fabric was produced in the same manner as in Example 1 except that the amount of MPO was changed to 20 mol %. The obtained circular-knitted fabric was dyed at a dyeing temperature of 95° C. and the L* value thereof was measured to be 25.2. The dry-heat shrinkage rate of the fabric was found good.

### Example 9

A polyester fabric was produced in the same manner as in Example 1 except that the amount of PEG 1000 was changed to 10 wt %. The obtained circular-knitted fabric was dyed at a dyeing temperature of 95° C. and the L* value thereof was measured to be 25.0. The dry-heat shrinkage rate of the fabric was found good.

### Example 10

A polyester fabric was produced in the same manner as in Example 1 except that the amount of PEG 4000 was changed to 20 wt %. The obtained circular-knitted fabric was dyed at a dyeing temperature of 95° C. and the L* value thereof was measured to be 27.3. The dry-heat shrinkage rate of the fabric was found good.

### Example 11

An undrawn yarn was obtained in the same manner as in Example 1 except that the addition amount of MPO was changed to 8 mol % and the addition amount of PEG 1000 was changed to 3 wt %. The obtained undrawn yarn was drawn at a drawing temperature of 90° C. and a drawing ratio of 1.65, and then was wound up after heat treatment at a setting temperature of 160° C., and a drawn yarn of 56 dtex/24 filaments was thus obtained. According to the same evaluation method as that in Example 1, The obtained circular-knitted fabric was dyed at a dyeing temperature of 95° C. and the L* value thereof was measured to be 25.7. The dry-heat shrinkage rate of the fabric was found excellent.

### Example 12

An undrawn yarn was obtained in the same manner as in Example 1 except that the addition amount of MPO was changed to 5 mol % and the addition amount of PEG 1000 was changed to 4 wt %. The obtained undrawn yarn was drawn at a drawing temperature of 90° C. and a drawing ratio of 1.65, and then was wound up after heat treatment at a setting temperature of 160° C., and a drawn yarn of 56 dtex/24 f was thus obtained. According to the same evaluation method as that in Example 1, the obtained circular-knitted was dyed at a dyeing temperature of 95° C. and the L* value thereof was measured to be 25.5. The dry-heat shrinkage rate of the fabric was found excellent.

1. A copolyester, characterized in that: based on the diacid components constituting the copolyester, the content of terephthalic acid structural unit is 90 mol % or more; based on the diol components constituting the copolyester, the content of ethylene glycol structural unit is within the range of 70-99 mol %, and the content of aliphatic diol structural unit having a side chain and a carbon atom number of 6 or less is 1-30 mol %; and the copolyester further contains polyethylene glycol structural unit.

2. The copolyester according to claim 1, characterized in that based on the diol components constituting the copolyester, the content of the aliphatic diol structural unit having a side chain and a carbon atom number of 6 or less is 6-20 mol %.

3. The copolyester according to claim 1 or claim 2, characterized in that the aliphatic diol structural unit having a side chain and a carbon atom number of 6 or less is 2-methyl-1,3-propanediol.

4. The copolyester according to claim 1 or claim 2, characterized in that the molecular weight of the polyethylene glycol structural unit is in the range of 1,000-10,000 g/mol.

5. The copolyester according to claim 1, characterized in that the total amount of the polyethylene glycol structural unit accounts for 1-30 wt % of the total amount of the copolyester.

6. A method for preparing the copolyester of claim 1, characterized in that the copolyester is prepared by polymerizing 100 parts by weight of diacid, 56-93.4 parts by weight of diol and 1.15-35 parts by weight of polyethylene glycol, wherein the content of terephthalic acid is 90 mol % or more based on the diacid, and the content of ethylene glycol and the content of aliphatic diol having a side chain and a carbon atom number of 6 or less are 70-99 mol % and 1-30 mol %, respectively, based on the diol.

7. The method for preparing according to claim 6, characterized in that the mole ratio of the diacid to the diol is 1:1.5-2.5.

8. Use of the copolyester of claim 1 for producing fiber.
